(19) United States
(12) Patent Application Publication
(10) Pub. No.: US 2006/0095963 A1
(43) Pub. Date: May 4, 2006

(54) Collaborative attack detection in networks

(76) Inventors: Simon Crosby, San Francisco, CA (US); John M. Agosta, Palo Alto, CA (US); Denver Dash, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/976,426

(22) Filed: Oct. 29, 2004

(51) Int. Cl. G06F 12/14

(52) U.S. Cl. 726/22

(57) ABSTRACT

A method and apparatus for collaborative attack detection in networks. An embodiment of a method comprises generating a first security belief for a first element of a network, receiving a second security belief for a second element of a network, and revising the first security belief based at least in part on the second security belief.

### FIELD

An embodiment of the invention relates to computer security in general, and more specifically to collaborative attack detection in networks.

### BACKGROUND

The need for more advanced computer security has continued to rise as computers attacks have become more varied and sophisticated. Computer networks contain vital data and thus strong security measures are necessary to prevent the compromise of such data. However, conventional computer security does not provide adequate protection because it does not reflect how computer attacks have evolved.

Conventional security software and hardware includes virus/worm and intrusion detection and prevention systems. Conventional systems typically take the form of either network-based devices, such as intrusion detection systems (IDS) and firewalls, or end-system based software, such as virus detection software. Such systems are ill equipped to deal with many forms of attack. Network devices face the challenge of detecting increasingly sophisticated attacks on increasingly high-speed links. An IDS or firewall must be able to understand the potential threat of every conversation that traverses it. Moreover, such network perimeter-based protection systems cannot protect an enterprise from attacks that originate within the enterprise network, for example from an infected laptop computer unwittingly attached to the corporate network by an employee.

Virus or worm detection systems must be able to identify all types of new attacks, even when the form of the attack varies, which is impossible to accomplish in conventional systems that rely on the use of signatures or rules to detect attacks.

Further, the application of conventional security methods that rely on the use of signatures or rules, or on the use of so-called anomaly detectors, to the many varied types of attacks that can occur results in a high incidence of false alarms—alarms that are raised when in fact no attack has taken place, and false-negatives—failures to sound an alarm when in fact an attack has taken place. In order to detect security violations, conventional systems may rely on overly sensitive detection, thereby creating false positives that greatly outnumber the number of true security threats that are detected, and thereby reducing system efficiency.

### BRIEF DESCRIPTION OF THE DRAWINGS

The invention may be best understood by referring to the following description and accompanying drawings that are used to illustrate embodiments of the invention. In the drawings:

FIG. 1 is an illustration of an embodiment of a system to provide collaborative attack detection;

FIG. 2 is an illustration of an embodiment of a system to establish security beliefs for an enterprise;

FIG. 3 is a diagram to illustrate an embodiment of element sub-models to detect security violations;

FIG. 4 is a embodiment of the propagation of beliefs in a network;

FIG. 5 is a flow chart an embodiment of creation and propagation of beliefs; and

FIG. 6 is a block diagram of an embodiment of a computer system for collaborative detection of attacks.

### DETAILED DESCRIPTION

A method and apparatus are described for collaborative attack detection in networks.

For the purposes of this description:

“Collaborative attack detection” means the collaboration of multiple elements in an enterprise's IT (information technology) infrastructure to detect an attempted security breach of the IT infrastructure.

In an embodiment of the invention, a network or other system includes a collaborative attack detection system. In one embodiment, elements of a network develop and report beliefs regarding attacks or security violations. In one embodiment, security beliefs of multiple elements are considered to identify a security threat or attack.

In one embodiment of the invention, each element of a network makes a determination regarding the security status of the network. In one embodiment, an element of a network transmits a belief regarding the security status to another element of the network. In one embodiment, an element of a network recalculates a belief regarding the security status of the network when a belief from another element is received. In one embodiment, beliefs regarding the security status of a network are distributed according to an epidemic propagation model.

Any detector may be subject to creating false positives and false negatives, no matter how effective it may be at correctly identifying attacks (true positives). An embodiment of the invention provides a system that uses a plurality of detectors located on a plurality of networked elements, combined with methods for local transformation of a detector outputs into a belief that the system is under attack; for transmission of beliefs between elements, either in a pre-determined manner or randomly; for synthesizing the beliefs of one or more elements into a belief that the system is under attack; and for dramatically reducing the number of false positives and false negatives through the synthesis of weak evidence drawn from a number of elements.

In computer networks, a sophisticated attacker may potentially attack an entire organization or a number of hosts on a network, such as the Internet, by slowly probing, compromising, or otherwise infiltrating one or more machines. A novel type of attack or a slow-paced attack may fail to be detected by conventional systems because the changes made to any one element in a period of time may be very small or may, on their own, may seem innocuous. In one possible example, an attacker could perform a port scan across the entire organization by randomly picking hosts and port numbers and inter-connection times. The attack may not be detected by conventional means because of the subtlety of the attack at any point in the organization.

In an embodiment of the invention, a security detector is located on each of a number of networked elements, with the abilities of the multiple detectors being leveraged together. In one embodiment, evidence that is drawn from multiple detectors is combined to increase detection rates. In one embodiment, a combination of intelligence across multiple detectors is utilized to increase the detection ability of a system and to reduce the frequency of false alarms. The effect of an attack may be difficult to detect for each individual machine, but the individual effects may be correlated into strong evidence regarding the state of the system.

In one embodiment of the invention, multiple security detectors are based within an enterprise or system, rather than detectors being based only at the network boundary. The internal basing of detectors may allow more accurate detection of internally launched attacks. In one embodiment of the invention, each element in a system maintains a set of sensors that monitor various key measures of system behavior, including, but not limited to, data connection rate, the rate of data transfer, the identities of its remote communicating peers, the rate of data transfer to disk, the rate of CPU (central processing unit) utilization, and other elements. These measures may be chosen to provide evidence of a probabilistic nature of anomalous behavior on the local system, which could indicate an attack. In one embodiment, an existing state-of-the-art virus and intrusion detection modules may also employed in conjunction with collaborative attack detection.

In one embodiment of the invention, each application or system in a network maintains a local model of behavior for security. In an embodiment, a system-wide model, which would provide interpretations of all possible combinations of application-specific behaviors, is not required. In an embodiment, each element of a system reacts individually to security issues according to its own security model.

In an embodiment, each element in a system forms probabilistic “beliefs” about its own security status and the security status of the whole system. In an embodiment of the invention, network detectors propagate beliefs regarding security status. In an embodiment, the propagation of beliefs, rather simply data, allows each client, server, or other networked element to determine for itself whether there is an attack and to communicate this belief for other elements. Under an embodiment of the invention, each element in a system makes its own conclusion regarding the security status and forwards this conclusion on to other elements. In an embodiment, each element in a network (which may include clients, servers, routers and switches) is responsible for identifying threats to itself and the network as a whole and for propagating observations to other elements. In one embodiment, the local belief of a system element is updated as beliefs are received from other elements. In one embodiment, beliefs may be sent periodically or may be triggered by some event. In an alternative embodiment, the belief of each system element is sent to a central repository, and the central repository may develop a global security belief based on the beliefs received from such elements. In one embodiment the central repository is responsible for forwarding the global belief or the local beliefs of the individual system elements.

In one embodiment, a belief of an element comprises a probability that a security threat is present. For example, a probability may be expressed as a fraction of one or as a percentage (such as a probability of 0.5 or a percentage of 50% indicating a one in two chance of a security violation). In one embodiment, a belief may contain other information, such as a belief regarding the type of security threat being faced or the source of a suspected attack. In one embodiment of the invention a belief propagation protocol may be augmented to carry with it not only the beliefs about the attack status of the system, but also data such as virus or worm signatures that might help other elements that have not yet seen the attack to defend themselves against it, and to allow other elements to collaborate in determining the correct signatures by correlating beliefs from a number of elements in the system.

Under an embodiment, a network detection system utilizes belief propagation to combine the observations from multiple elements in the network for the purpose of detecting correlated evidence of an attack. Evidence that is too weak to trigger an alarm for a local detector may be combined with other weak evidence from other machines in the system, thereby creating a result that may include compelling evidence of a security violation. In one embodiment, each element of a system is responsible for pooling its observations with the observations of other elements, thereby enabling all networked elements to rapidly assemble sufficient evidence to infer the security state of the system as a whole. In an embodiment, the pooled beliefs for the entire system represent a belief regarding the entire system, which may be referred to as a “population belief” or “global belief”. In one embodiment, each networked element maintains a locally held population belief, which is re-computed based on updates that the element receives. Each locally held population belief therefore represents a partial computation of the true population belief, since a locally held belief does not necessarily contain all evidence from all elements in the system.

In one embodiment of the invention, a system does not require the combination of evidence from all elements in the network to infer that an attack is taking place on the system. Instead, a conclusion regarding security only requires assembly of sufficient evidence from a subset of system elements whose observations are strong enough to allow an element to infer that the system is under attack. A network embodiment utilizing a belief propagation process thus may operate very efficiently in terms of communications bandwidth and computational overhead.

In one embodiment of the invention, a collaborative approach to diagnosing the security of the network as a whole utilizes a distributed solution of a Bayesian belief model, a known computational model. In one embodiment, a network utilizes a Bayesian Network model, in which each node or element of a network is responsible for solution of a subset of the problem (a sub-model) using statistical inference. In one embodiment, an element of a network is further responsible for propagating its beliefs about security to the other elements of the network. In one embodiment, the beliefs of a networked element are updated based at least in part on beliefs received from other elements. In such a system, each node that receives updated beliefs from another node utilizes an update procedure to factor the new beliefs into its view regarding both its own security state and the security state of the system as a whole. In one embodiment, all elements rapidly learn about new attacks on the system and thus can take preventive measures to protect themselves or raise a general system-wide alarm.

In one embodiment of the invention, each node in a system recalculates its local security belief and its locally held population belief. The recalculation may occur according to factors that vary with the particular embodiment. For example, recalculation may occur periodically after a certain time period, whenever local element evidence changes, or upon the receipt of a propagated belief from a peer element in the system. Under an embodiment of the invention, a networked element updates its locally held population belief utilizing changes in the element's own local beliefs or beliefs received from other elements in the networked system. The recipient of an updated belief factors the new belief into its own locally held population belief, with the belief being based on the total of all evidence that has been received. If an element has already received a new belief or has received evidence that is newer, the new belief may be discarded or appropriately factored into the computation of the new population belief. Therefore, as beliefs are propagated through a system, the locally held beliefs converge towards a correct belief about the actual security state of the system.

In an embodiment of the invention, the beliefs of multiple elements of a network are spread to other elements of the network, with the recipients using the beliefs to modify their own beliefs. In one embodiment, locally held beliefs are transmitted using an epidemic protocol model. An embodiment of the invention uses the dissemination process to pool evidence together and to quickly propagate news about attacks, thereby potentially outrunning virulent worms and viruses. In one embodiment of the invention, each node of a network propagates its beliefs to other nodes in a probabilistic fashion, using a protocol that is similar in behavior to the spread of a computer or biological virus. An epidemic protocol is extremely robust to failure and able to rapidly propagate information to all other elements, and will damp down naturally as elements begin to know the information being spread. In one embodiment, the use of epidemic protocols allows propagation of information and beliefs about a new attack in a way that mimics the spread of security attacks themselves. In one embodiment, the propagation of security information is made directly to other elements, with each element making local conclusions regarding the security state. An embodiment of a network is able as a whole to respond quickly to a security attack, and thus attempt to protect itself before the attack can spread.

In one embodiment, periodically, or when its population belief changes, a node propagates its population belief to one or more peers in the system. The node encodes its population belief, which is conditioned on all evidence that the node has received to date, and randomly chooses a peer to which to propagate the change. The node transmits the updated belief to the peer. The peer may then recalculate its beliefs and transmit the recalculated beliefs to another randomly chosen peer. The process then continues and quickly spreads the security beliefs throughout the system.

An embodiment of the invention may work in conjunction with or along side conventional security apparatus. In possible example, an embodiment of the invention may exist together with a virus detection program and a system firewall and provide added security protection beyond what is provided by conventional security processes.

In one embodiment, any machine in a network may take action to address a potential security threat when the security belief of the machine reaches a threshold. If the computed local or population belief at any node crosses a threshold, which may be a local threshold set by the administrator of the node, then the node may conclude that either the node or the entire system is under attack. When this occurs, the node may take such actions as alerting an operator, implementing preventive measures to preclude compromise, and sending an alert to another node in the system using the epidemic protocol.

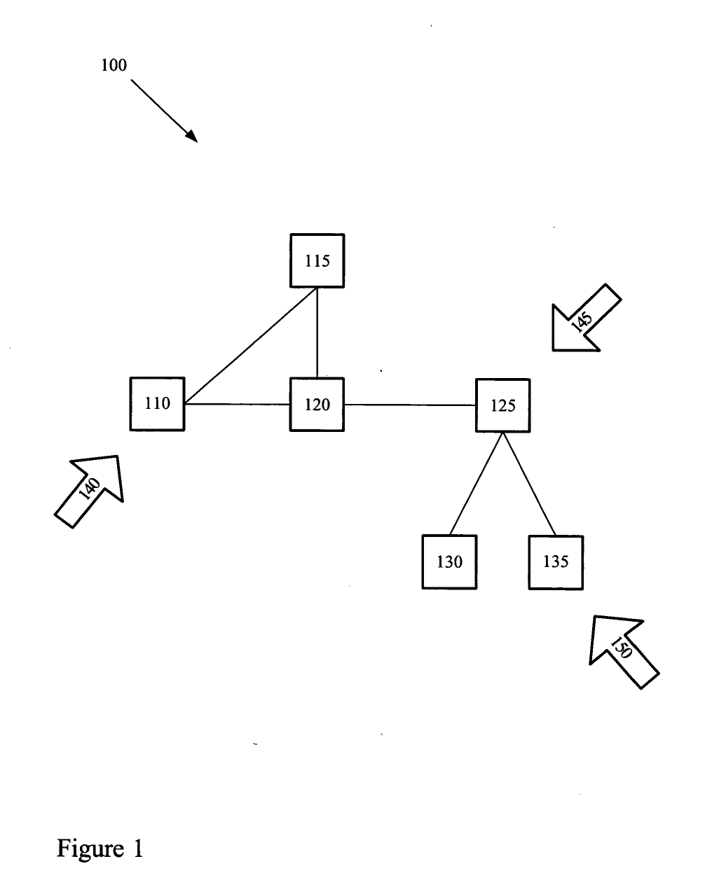

FIG. 1 is an illustration of an embodiment of a system to provide collaborative attack detection. In this illustration, a network or other enterprise 105 includes a number of elements 110 through 135 that may be connected in any manner. Each of the elements represents a part of the network 105, such as a client, a server, a router, or a switch. In this illustration, an attack is made against the network 105. An attack may include an attack on one or more elements of the network 105, such as a first attack 140 on a first element 110, a second attack 145 on second element 125, and a third attack 150 on a third element 135.

In an embodiment of the invention, the network may detect the global attack even though the individual attacks may be insufficient in themselves to set off any alarms. In an embodiment of the invention, each of the elements may develop local security beliefs regarding the likelihood of an attack on the element and on the network 105, with a combination of the local beliefs regarding likelihood of attacks on the network representing a global or population belief regarding such an attack. Each local belief may be updated upon a certain occurrence, such as a passage of time, the detection of changed conditions, or the receipt of beliefs from another element. In one embodiment, the propagation of beliefs may be sent in the form of an epidemic model. In an embodiment of the invention, each element will forward the local beliefs of the element regarding an attack to one or more other elements of the network 105. For example, the first element 110 may develop local beliefs regarding an attack and may forward the local beliefs on to another random element of the network 105. The receiving element may also recalculate its local beliefs based on all of the evidence so far received and forward its beliefs on to another element, thus continuing the spread of the beliefs throughout the network

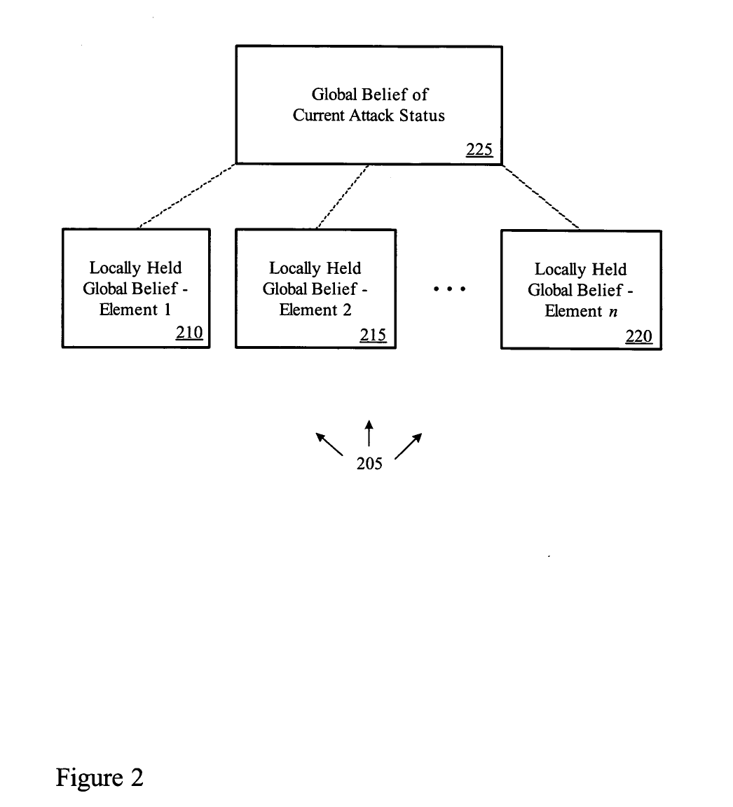

FIG. 2 is an illustration of an embodiment of a system to establish security beliefs for an enterprise. In this illustration, a global belief of regarding the current attack status 225 is represented by a combination of locally held beliefs regarding a global attack 205. In this illustration the locally held beliefs 205 may include a belief from a first element 210, a belief from a second element 215, and continuing through a belief from an nth element 220. In an embodiment of the invention, each element develops its locally held belief based on its own observations and based on the local beliefs that are received from other elements. It is not necessary that all local beliefs be received by any element. An element may receive sufficient information from a subset of beliefs to make a determination regarding whether an attack on the network is occurring.

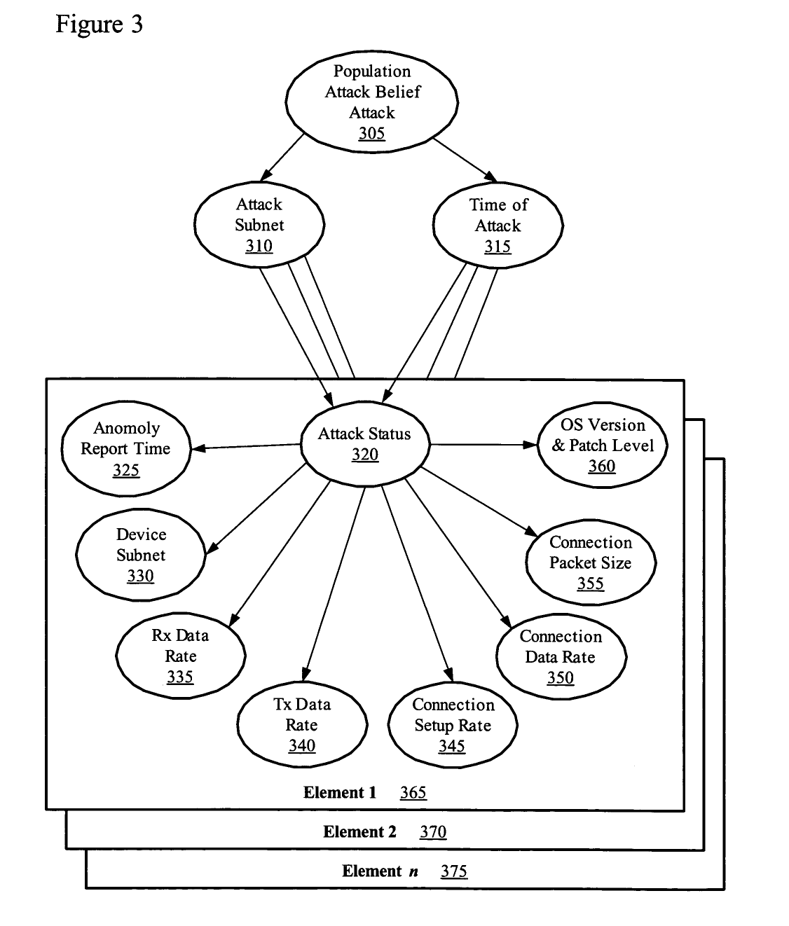

FIG. 3 is a diagram to illustrate an embodiment of element sub-models to detect security violations. FIG. 3 illustrates figuratively how a population attack belief is formed. In one embodiment of the invention, a network may include multiple networked elements. Each of the elements includes a sub-model that is used to form a locally held belief regarding the status of an attack on the element, with the local held beliefs then being combined to form a population attack belief 305.

The sub-model for a first element 365 is illustrated, with sub-models also existing for each other elements, such as a second element 370 through an nth element 375. In this illustration, the population attack belief is linked to the elements via interface nodes that represent the attack subnet 310 and the time of attack 315. In this example, the attack subnet 310 and the time of attack 315 are linked to the attack status 320 formed by the element sub-model. The attack status 320 for the respective element then is a combination of factors that may be indicative of an attack on the networked element. These elements may vary with the embodiment and may vary between individual networked elements. In this illustration, the factors for the first elements include an anomaly report time 325 (indicating timing of anomalous events, which may provide some evidence of outside influences); a device subnet 330; a receiver data rate 335; a transmitter data rate 340 (a change in data reception or transmission rate may indicate improper activity for the networked element); connection setup rate 345; connection data rate 350 (changes in connection setup and data rate may indicate an attack compromising connection processes); connection packet size 355 (an increase in packet size may indicate that additional data is being transmitted by an attacker); and operating system (OS) version and patch level 360.

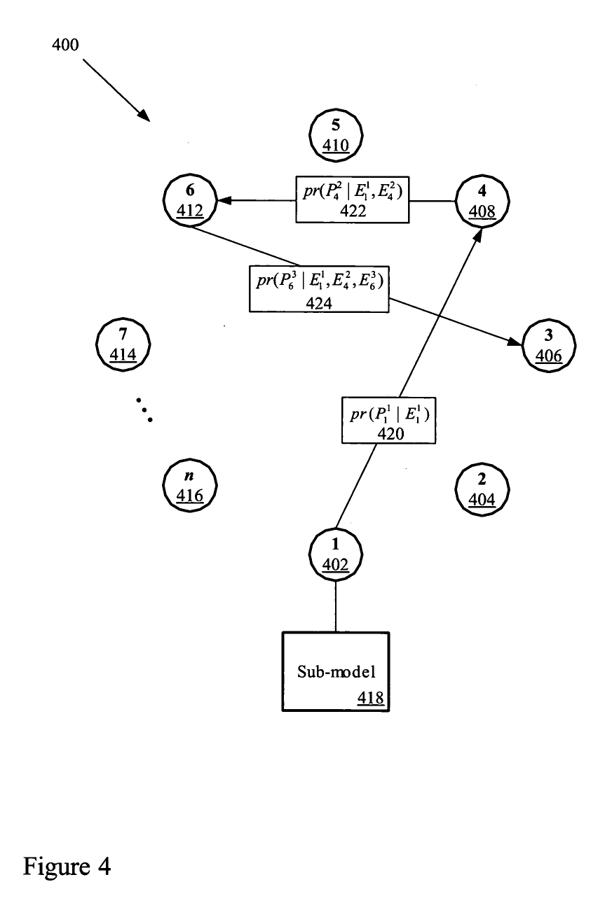

FIG. 4 is a embodiment of the propagation of beliefs in a network. Under an embodiment of the invention, an epidemic model of propagation of beliefs may be utilized. Numerous epidemic models are known and the details regarding the propagation model may vary according the particular embodiment. In this illustration, a network 400 includes a number of networked elements. The elements may be connected in any known network manner and may include any number of elements. In FIG. 4, the elements include a first element 402, a second element 404, a third element 406, a fourth element 408, a fifth element 410, a sixth element 412, a seventh element 414, and continuing through an nth element 416. Each of the elements includes a local model to establish a local belief regarding an attack on the network 400, with, for example the local sub-model 418 for the first element 418 being illustrated.

In FIG. 4, the local sub-model 418 of the first element 402 develops beliefs regarding the status of any attacks on the element or the network 400. In one embodiment, elements may transmit beliefs periodically. In another embodiment, an element may transmit a belief when the belief has changed. In this illustration, the belief is shown as pr(Pₐ^{b}|E_{c}^{d}), indicating the belief in the event of a global attack P at time b for element a based on evidence E local to element c at time of observation d.

In FIG. 4, the first element 402 sends its belief regarding the current attack status of the network to a random element of the network 400, with the chosen element in this example being the fourth element 408. The belief transmitted 420 from the first element 402 to the fourth element 408 is represented by pr(P₁¹|E₁¹), indicating the belief in a global attack P at time 1 for the first element based on evidence E local to the first element at time 1.

The transmitted belief 420 may be used by the fourth element 408 to recalculate a locally held belief regarding the attack status for the network. The recalculated belief may then be transmitted to another random element, such as, for example, the sixth element 412. The belief transmitted 422 from the fourth element 408 to the sixth element 412 is represented by pr(P₄²|E₁¹, E₄²), indicating a belief in a global attack P at time 2 for the fourth element based on evidence E local to the first element at time 1 and evidence E local to the fourth element at time 2.

The belief 422 may be used by the sixth element 412 to recalculate the relevant locally held belief regarding the attack status for the network. This belief may then be transmitted to a random element, which is, for example, the third element 406. The belief transmitted 424 from the sixth element 412 to the third element 406 is represented by pr(P₆³|E₁¹, E₄², E₆³), indicating the belief in a global attack P at time 3 for the sixth element based on evidence E local to the first element at time 1, evidence E local to the fourth element at time 2, and evidence E local to the sixth element at time 3. The process of propagation of revised beliefs may continue to spread throughout the network until the change in belief has damped out or the information becomes too old and is then ignored. The locally held beliefs converge towards a global belief regarding the security state of the system.

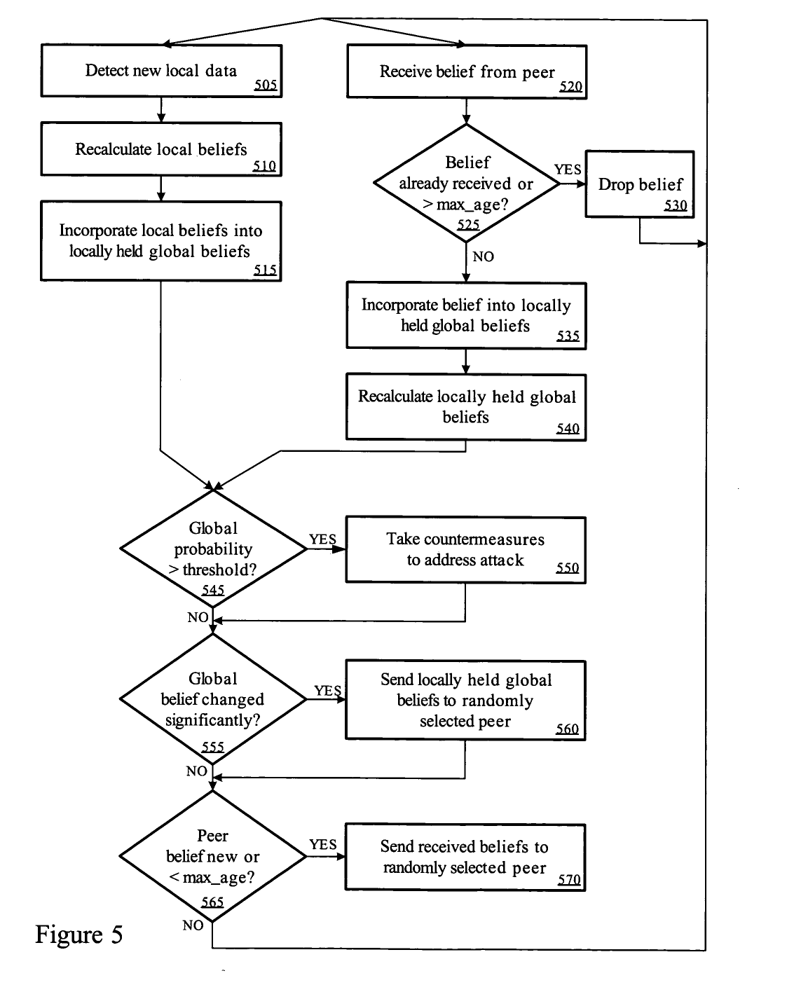

FIG. 5 is a flow chart to illustrate an embodiment of creation and propagation of beliefs. In this illustration, a networked element has established local beliefs regarding the security of the element and locally held global beliefs regarding security of the network, with local beliefs being based at least in part on local data bearing on the security of the element. If new local data is detected 505, then the local beliefs are recalculated 510 and local beliefs are incorporated into the locally held global beliefs. If beliefs regarding security are received 520, there is a determination whether the received beliefs have already been received or are older than a maximum age value 525. If so, the beliefs are dropped from further consideration 530. If not, the received beliefs are incorporated into the locally held global beliefs 535 and the locally held global beliefs are recalculated 540.

If the new locally held global beliefs have a probability that is greater than a certain threshold established for the element 545, then appropriate countermeasures are taken to address the detected attack against the network 550. If the locally held global beliefs have changed significantly 555, then the beliefs are sent to a randomly selected peer in the network 560. For any received peer beliefs that are new or are less than the maximum age value 565, the peer beliefs are send to a randomly selected peer in the network 570.

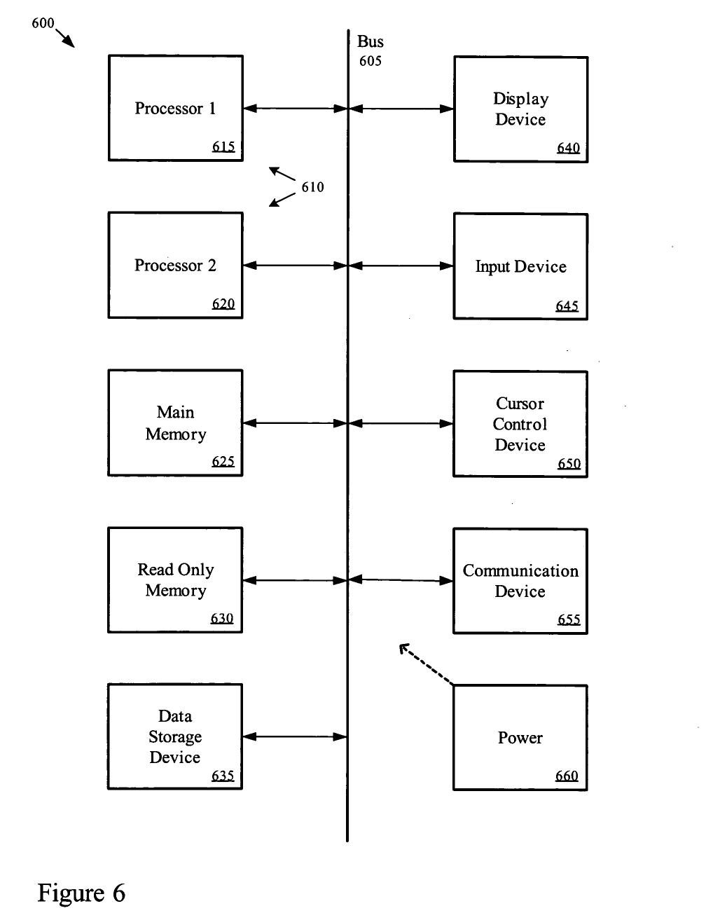

FIG. 6 is a block diagram of an embodiment of a computer system for collaborative detection of attacks. In one embodiment, the computer system is connected to one or more systems in a network to provide protection against collaborative attacks. Under an embodiment of the invention, a computer 600 comprises a bus 605 or other communication means for communicating information, and a processing means such as two or more processors 610 (shown as a first processor 615 and a second processor 620) coupled with the first bus 605 for processing information. The processors 610 may comprise one or more physical processors and one or more logical processors. In one embodiment of the invention, distributed security operation functions are built into the processors 610 or other devices having processing ability.

The computer 600 further comprises a random access memory (RAM) or other dynamic storage device as a main memory 625 for storing information and instructions to be executed by the processors 610. Main memory 625 also may be used for storing temporary variables or other intermediate information during execution of instructions by the processors 610. In an embodiment of the invention, instructions for response to collaborative attacks may be loaded in main memory 625. In addition, main memory 625 may include a virus check program that works in conjunction with or in addition to the instructions for response to collaborative attacks. The computer 600 also may comprise a read only memory (ROM) 630 and/or other static storage device for storing static information and instructions for the processors 610.

A data storage device 635 may also be coupled to the bus 605 of the computer 600 for storing information and instructions. The data storage device 635 may include a magnetic disk or optical disc and its corresponding drive, flash memory or other nonvolatile memory, or other memory device. Such elements may be combined together or may be separate components, and utilize parts of other elements of the computer 600.

The computer 600 may also be coupled via the bus 605 to a display device 640, such as a cathode ray tube (CRT) display, a liquid crystal display (LCD), a plasma display, or any other display technology, for displaying information to an end user. In some environments, the display device may be a touch-screen that is also utilized as at least a part of an input device. In some environments, display device 640 may be or may include an audio device, such as a speaker for providing audio information. An input device 645 may be coupled to the bus 605 for communicating information and/or command selections to the processors 610. In various implementations, input device 645 may be a keyboard, a keypad, a touch-screen and stylus, a voice-activated system, or other input device, or combinations of such devices. Another type of user input device that may be included is a cursor control device 650, such as a mouse, a trackball, or cursor direction keys for communicating direction information and command selections to the one or more processors 610 and for controlling cursor movement on the display device 640.

A communication device 655 may also be coupled to the bus 605. Depending upon the particular implementation, the communication device 655 may include a transceiver, a wireless modem, a network interface card, or other interface device. In one embodiment, the communication device 655 may include a firewall to protect the computer 600 from improper access. The computer 600 may be linked to a network or to other devices using the communication device 655, which may include links to the Internet, a local area network, or another environment. The computer 600 may also comprise a power device or system 660, which may comprise a power supply, a battery, a solar cell, a fuel cell, or other system or device for providing or generating power. The power provided by the power device or system 660 may be distributed as required to elements of the computer 600.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various processes. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. A method comprising:
generating a first security belief for a first networked element of a network;
receiving a second security belief for a second networked element of the network; and
revising the first security belief based at least in part on the second security belief.

2. The method of claim 1, further comprising transmitting the first security belief to another networked element of the network.

3. The method of claim 2, wherein the revised first security belief is sent to a random element of the network.

4. The method of claim 1, wherein the first security belief comprises a probability that the network is subject to a security breach.

5. The method of claim 4, further comprising a generating a local security belief, the local security belief comprises a probability that the first networked element is subject to a security breach, the first security belief being based at least in part on the local security belief.

6. The method of claim 5, wherein the local security belief is based at least in part on one or more factors affecting the first networked element.

7. The method of claim 6, further comprising revising the local security belief based at least in part on revision of one or more of the factors affecting the first networked element, and incorporating the revised local belief into the first security belief.

8. The method of claim 4, further comprising determining that a network security breach has occurred if the probability of a network security breach is greater than a threshold value.

9. The method of claim 8, further comprising taking an action to protect the first networked element from the network security breach.

10. A networked element comprising:
a detector to detect a data element for the networked element;
a memory to store the data element;
a processing unit to calculate a first local security belief based at least in part on the data element and a first network security belief based at least in part on the first local security belief; and
an interface with a network to receive a second network security belief from another networked element, the processing unit to recalculate the first network security belief based at least in part on the second network security belief.

11. The networked element of claim 10, wherein the first network security belief comprises a belief regarding the probability of an attack on the network.

12. The networked element of claim 11, wherein the first local security belief further comprises a belief regarding the probability of an attack on the networked element.

13. The networked element of claim 10, wherein the networked element is to send the recalculated first network security belief to another networked element.

14. The networked element of claim 13, wherein the networked element that is sent the recalculated first network security belief is chosen at random.

15. The networked element of claim 10, wherein the memory further is to store a security model for the networked element.

16. A security system comprising:
a plurality of detectors, a detector being a part of each of a plurality of networked elements; and
a memory for each of the plurality of networked elements, each memory containing a security belief generated by the networked element, the security belief being based at least in part on data collected for the networked element and any security beliefs received from other networked elements.

17. The security system of claim 16, wherein each networked element is to recalculate the security belief of the networked element when a security belief is received from another networked element, the recalculated belief being based at least in part on the received security belief;

18. The security system of claim 16, wherein each networked element is to transmit the security belief of the networked element to another networked element.

19. The security system of claim 16, wherein the security system is to propagate the security beliefs using an epidemic protocol.

20. The security system of claim 16, wherein the networked elements are to collaboratively calculate a belief regarding the security of the network using a Bayesian Network model.

21. The security system of claim 20, wherein the collaboratively calculated belief is calculated from the security beliefs for all or a subset of the networked elements.

22. The security system of claim 16, further comprising one or more of an intrusion detection system and a virus detection program.

23. A machine-readable medium having stored thereon data representing sequences of instructions that, when executed by a processor, cause the processor to perform operations comprising:
generating a local security belief for a first device in a network;
generating a first network security belief, the first network security belief being based at least in part on the local security belief;
receiving a second network security belief from a second device in the network; and
revising the first network security belief based at least in part on the second network security belief.

24. The medium of claim 23, wherein the instructions further comprise instructions that, when executed by a processor, cause the processor to perform operations comprising sending the first network security belief to a random device in the network.

25. The medium of claim 23, wherein the instructions further comprise instructions that, when executed by a processor, cause the processor to perform operations comprising sending the second network belief to a random element of the network.

26. The medium of claim 23, wherein the instructions further comprise instructions that, when executed by a processor, cause the processor to perform operations comprising revising the local security belief based at least in part on data detected by the first device and comprising revising the first network security belief based at least in part on the revised local security belief.

27. The medium of claim 23, further comprising disregarding a third network security belief if the third network security belief has previously been received or if the third network security belief is older than a certain age.

28. The medium of claim 23, wherein the instructions further comprise instructions that, when executed by a processor, cause the processor to perform operations comprising determining that the first network security belief comprises a probability of a security breach that is greater than a certain threshold.

29. The medium of claim 28, wherein the instructions further comprise instructions that, when executed by a processor, cause the processor to perform operations comprising instituting countermeasures to address the security breach.
